(19) United States
(12) Patent Application Publication
(10) Pub. No.: US 2011/0292324 A1
(43) Pub. Date: Dec. 1, 2011

(54) IPS or FFS mode liquid crystal display device

(75) Inventors: Hiroyuki Kaihoko, Kanagawa (JP); Jun Takeda, Kanagawa (JP)

(73) Assignee: FUJIFILM Corporation, Tokyo (JP)

(21) Appl. No.: 13/067,291

(22) Filed: May 23, 2011

(30) Foreign Application Priority Data
May 25, 2010 (JP) 2010-118887

(51) Int. Cl. G02F 1/1335

(52) U.S. Cl. 349/96

(57) ABSTRACT

An IPS or FFS mode liquid crystal display device is disclosed. The device comprises a first optical film, fulfilling the conditions of formulas (I)-(IV), consisting of a layer with low degree of total acyl substitution comprising a cellulose acylate as a main ingredient, or comprising the layer with low degree of total acyl substitution and an outermost layer with high degree of total acyl substitution comprising a cellulose acylate as a main ingredient, disposed on at least one surface of the layer with low degree of total acyl substitution:

0 nm≦Re(550)≦10 nm, (I)

|Rth(550)|≦25 nm, (II)

|Re(630)−Re(450)|≦10 nm, (III)

|Rth(630)−Rth(450)|35 nm. (IV)

### CROSS-REFERENCE TO RELATED APPLICATIONS

The present application claims the benefit of priority from Japanese Patent Application No. 2010-118887, filed on May 25, 2010, the contents of which are herein incorporated by reference in their entirety.

### BACKGROUND OF THE INVENTION

1. Field of the Invention

The present invention relates to liquid crystal display devices employing an IPS or FFS mode.

2. Background Art

In the IPS (In-Plane Switching) or FFS (Fringe Field Switching) mode, the molecules are driven by applying an electric field containing a component substantially parallel to the substrate so as to respond in the direction parallel to the surface of the substrates, unlike the TN mode in which the molecules are driven by applying an electric field between the upper and lower substrates so as to rise. The liquid crystal display devices employing the IPS or FFS mode achieve excellent viewing-angle properties, and therefore, they have various uses such as TV panels. Low-retardation films have been used as an inner protective film of the polarizing plates for reducing light leakage in the black state (for example, JP-A-2006-227606).

On the other hand, using cellulose acylate having a low degree of acyl-substitution as a material of protective films of polarizing plates has been proposed (for example, JP-A-2009-265598).

### SUMMARY OF THE INVENTION

However, the inventors found that the color-shift occurred when the liquid crystal display device in the black state, having a low-retardation film as the inner protective film of the polarizing film, was observed in the oblique direction. For the display devices which may be observed in various directions such as TV, it is important to reduce the color-shift.

One object of the invention is to provide an IPS or FFS mode liquid crystal display device in which the color shift, occurring in the oblique direction in the black state, is reduced.

The means for achieving the object are as follows.

[1] An IPS or FFS mode liquid crystal display device comprising:
a first and a second polarizers of which polarizing axes are perpendicular to each other;
a liquid crystal layer disposed between the first and the second polarizers; and
a first optical film disposed between the first polarizer and the liquid crystal cell and a second optical film disposed between the second polarizer and the liquid crystal cell; wherein
the first and the second optical films fulfill the conditions of formulas (I)-(IV); and
the first optical film consists of a layer with low degree of total acyl substitution comprising a cellulose acylate fulfilling the condition of formula (1) as a main ingredient, or comprises the layer with low degree of total acyl substitution and an outermost layer with high degree of total acyl substitution comprising a cellulose acylate fulfilling the condition of formula (2) as a main ingredient, disposed on at least one surface of the layer with low degree of total acyl substitution:

0 nm≦Re(550)≦10 nm (I)

|Rth(550)|≦25 nm (II)

|Re(630)−Re(450)|≦10 nm (III)

|Rth(630)−Rth(450)|35 nm (IV)

where, in formulas (I)-(IV), Re(λ) represents retardation (nm) in plane at a wavelength of λ nm, and Rth(λ) represents retardation (nm) at the thickness direction at a wavelength of λ nm;

2.0<Z1<2.7 (1)

where Z1 represents a total substitution degree of the cellulose acylate used as the main ingredient of the layer with low degree of total acyl substitution; and

2.7<Z2 (2)

where Z2 represents a total substitution degree of the cellulose acylate used as the main ingredient of the outermost layer with high degree of total acyl substitution.

[2] The liquid crystal display device of [1], wherein the second optical film comprises a layer with low degree of total acyl substitution comprising a cellulose acylate fulfilling the condition of formula (1) as a main ingredient, and an outermost layer with high degree of total acyl substitution, disposed on at least one surface of the layer with low degree of total acyl substitution, comprising a cellulose acylate fulfilling the condition of formula (2) as a main ingredient:
[3] The liquid crystal display device of [1] or [2], wherein the thicknesses of the first and the second optical films are from 30 to 130 micro meters.
[4] The liquid crystal display device of any one of [1]-[3], further comprising a third and a fourth optical films disposed at the outside of the first and the second polarizers, wherein at least one of the third and fourth optical films fulfills the conditions of formulas (I)-(IV), and comprises a layer with low degree of total acyl substitution comprising a cellulose acylate fulfilling the condition of formula (1) as a main ingredient, and an outermost layer with high degree of total acyl substitution, disposed on at least one surface of the layer with low degree of total acyl substitution, comprising a cellulose acylate fulfilling the condition of formula (2) as a main ingredient.
[5] The liquid crystal display device of any one of [1]-[4], wherein the layer with low degree of total acyl substitution comprises a non-phosphate ester compound.
[6] The liquid crystal display device of [5], wherein the outermost layer with high degree of total acyl substitution comprises a non-phosphate ester compound; and a ratio by mass of the non-phosphate ester compound with respect to the cellulose acylate in the outermost layer with high degree of total acyl substitution is less than a ratio by mass of the non-phosphate ester compound with respect to the cellulose acylate in the layer with low degree of total acyl substitution.
[7] The liquid crystal display device of [5] or [6], wherein the non-phosphate ester compound is a polyester compound having at least one aromatic ring.
[8] The liquid crystal display device of any one of [1]-[7], wherein the cellulose acylate in the layer with low degree of total acyl substitution fulfills the conditions of formulas (3)-(5):

1.0<X1<2.7 (3)

0≦1<1.5 (4)

X1+Y1=Z1 (5)

where, in formulas (3)-(5), X1 represents a degree of acetylation of the cellulose acylate used as the main ingredient of the layer with low degree of total acyl substitution; Y1 represents a degree of acyl-substitution having 3 or more carbon atoms of the cellulose acylate used as the main ingredient of the layer with low degree of total acyl substitution; and Z1 represents a total substitution degree of the cellulose acylate used as the main ingredient of the layer with low degree of total acyl substitution.

[9] The liquid crystal display device of any one of [1]-[8], wherein the cellulose acylate in the outermost layer with high degree of total acyl substitution fulfills the conditions of formulas (6)-(8):

1.2<X2<3.0 (6)

0≦Y2<1.5 (7)

X2+Y2=Z2 (8)

where, in formulas (6)-(8), X2 represents a degree of acetylation of the cellulose acylate used as the main ingredient of the outermost layer with high degree of total acyl substitution; Y2 represents a degree of acyl-substitution having 3 or more carbon atoms of the cellulose acylate used as the main ingredient of the outermost layer with high degree of total acyl substitution; and Z2 represents a total substitution degree of the cellulose acylate used as the main ingredient of the outermost layer with high degree of total acyl substitution.

[10] The liquid crystal display device of any one of [1]-[9], wherein the outermost layer with high degree of total acyl substitution is disposed on both of the surfaces of the layer with low degree of total acyl substitution. The formulations of the two outermost layers with high degree of total acyl substitution may be same or different to each other.
[11] The liquid crystal display device of any one of [1]-[10], wherein the number of carbon atoms contained in the acylate group of the cellulose acylate in the layer with low degree of total acyl substitution and/or the outermost layer with high degree of total acyl substitution is from 2 to 4.
[12] The liquid crystal display device of any one of [1]-[11], wherein the acylate group of the cellulose acylate in the layer with low degree of total acyl substitution and/or the outermost layer with high degree of total acyl substitution is cellulose acetate.
[13] The liquid crystal display device of any one of [1]-[11], wherein the averaged thickness of the layer with low degree of total acyl substitution is from 30 to 100 micro meters; and the averaged thickness of at least one of the outermost layer with high degree of total acyl substitution is not less than 0.2% and less than 25% of the averaged thickness of the layer with low degree of total acyl substitution.

According to the invention, it is possible to provide an IPS or FFS mode liquid crystal display device in which the color shift, occurring in the oblique direction in the black state, is reduced.

### BRIEF DESCRIPTION OF THE DRAWINGS

FIG. 1 is a schematic cross-sectional view of one example of the liquid crystal display device of the invention.

FIG. 2 is a schematic view of one example of a process for preparing a three-layered cellulose acylate film according to a simultaneous co-casting method employing a co-casting die.

In the drawing, the reference numerals and signs have the following meanings.
11 First polarizer
12 Second polarizer
13 IPS or FFS mode liquid crystal cell
14 First optical film
15 Second optical film
16, 17 Outer protective film

### DETAILED DESCRIPTION OF THE INVENTION

The invention is described in detail hereinunder. In this description, the numerical range expressed by the wording “a number to another number” means the range that falls between the former number indicating the lowermost limit of the range and the latter number indicating the uppermost limit thereof.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selectivity of the measurement wavelength λ nm may be conducted by a manual exchange of a wavelength-filter, a program conversion of a measurement wavelength value or the like.

When a film to be analyzed is expressed by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (A) and (B):

$$\begin{matrix}Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} & ( A ) \\ Rth = ( \frac{nx + ny}{2} - nz ) \times d & ( B )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In this description, the “slow axis” of the retardation film and others means the direction in which the refractive index is the largest. In the description, the measurement wavelength for Re or Rth is λ=550 nm in the visible light region, unless otherwise specifically noted.

And in the description, the numerical data, the numerical range and the qualitative expression (for example, “equivalent”, “same”, etc.) indicating the optical characteristics should be so interpreted as to indicate the numerical data, the numerical range and the qualitative expression that include the error range generally acceptable for liquid-crystal display devices and their component parts.

The present invention relates to an IPS or FFS mode liquid crystal display device having a low-retardation film as an inner protective film. One feature of the invention resides in that the low-retardation film consists of a layer with low degree of total acyl substitution containing a low-acylation degree cellulose acylate fulfilling the predetermined condition as a main ingredient, or comprises the layer with low degree of total acyl substitution and an outermost layer with high degree of total acyl substitution containing a high-acylation degree cellulose acylate fulfilling the predetermined condition as a main ingredient disposed on at least one surface of the layer with low degree of total acyl substitution. The inventors conducted various studies, and, as a result, found that low-retardation films, showing smaller haze, with a thinner thickness could be prepared by using a low-acylation degree cellulose acylate, fulfilling the predetermined condition, as a main ingredient, compared with those prepared by using a high-acylation degree cellulose acylate, fulfilling the predetermined condition, as a main ingredient. According to the invention, the color shift, occurring in oblique directions when being observed in the black state, can be reduced by using such a low-retardation film in an IPS or FFS mode liquid crystal display device.

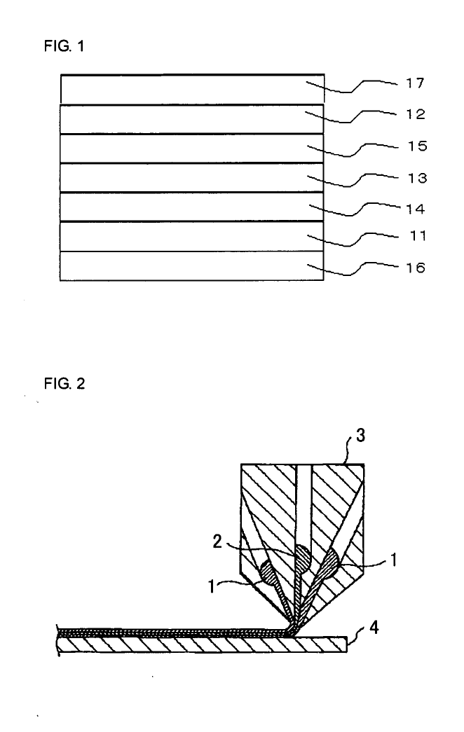

FIG. 1 shows a schematic cross-sectional view of one example of the liquid crystal display device of the invention. The liquid crystal display device shown in FIG. 1 has a first and a second polarizes 11 and 12, and an IPS or FFS mode liquid crystal cell 13. A first optical film 12 is disposed between the liquid crystal cell 13 and the first polarizer 11; and a second optical film 15 is disposed between the liquid crystal cell 13 and the second polarizer 12. The first and the second polarizers 11 and 12 are disposed so that their polarizing axes are perpendicular to each other. The liquid crystal cell 13 is an IPS or FFS mode liquid crystal cell in which the molecules are driven by applying an electric filed containing a component parallel to the substrates so as to respond in the direction parallel to the surface of the substrates, unlike the mode in which the molecules are driven by applying an electric field between the upper and lower substrates so as to rise. Outer protective films 15 and 16, formed of a polymer film such as a cellulose acylate film, are disposed at the outside of the first and the second polarizers 11 and 12 respectively.

It is to be noted that the observer side may be the upper or lower side in FIG. 1, and that both of the embodiments may show the same effect.

Both of the first and the second optical films 14 and 15 are low-retardation films, and fulfill the conditions of formulas (I)-(IV).

0 nm≦Re(550)≦10 nm (I)

|Rth(550)|≦25 nm (II)

|Re(630)−Re(450)|≦10 nm (III)

|Rth(630)−Rth(450)|≦35 nm (IV)

According to the invention, it is possible to reduce the light leakage occurring in oblique directions when being observed in the black state by disposing the first and the second optical films 14 and 15, fulfilling the above-described conditions, on and under the liquid crystal cell 13.

Furthermore, the first optical film 14 consists of the low-degree-substitution layer containing a cellulose acylate, fulfilling the condition of formula (1), as a main ingredient, or comprises the low-degree-substitution layer and a high-degree-substitution layer containing a cellulose acylate, fulfilling the condition of formula (2), as a main ingredient, disposed on at least one of the surfaces of the low-degree-substitution layer.

2.0<Z1<2.7 (1)

Z1 represents a total substitution degree of the cellulose acylate used as the main ingredient of the layer with low degree of total acyl substitution.

2.7<Z2 (2)

Z2 represents a total substitution degree of the cellulose acylate used as the main ingredient of the outermost layer with high degree of total acyl substitution.

The first optical film 14 exhibits the reversed wavelength dispersion characteristics because of having the low-degree-substitution layer, and according to the invention, it is possible to reduce the color shift, occurring in oblique directions when being observed in the black state, by using the low-retardation film exhibiting such characteristics. If the cellulose acylate having a smaller Z1 is used, the coefficient of water absorption of the cellulose acylate film may become larger, and the film may suffer from the lower-durability under an atmosphere of a high temperature and a high humidity.

Especially, the first optical film 14 preferably fulfills the conditions of formulas (II′) and (IV′).

|Rth(550)|<10 nm (II′)

5<|Rth(630)−Rth(450)|≦35 nm (IV′)

It is possible to further reduce the color shift occurring in oblique directions when being observed in the black state by using the film fulfilling the conditions of the two formulas. More specifically, it is possible to further reduce Δv′, which is an indicator of the color shift, to a value of equal to or less than 0.8.

And the thickness of the first optical film 14 is preferably from 30 to 70 micro meters, more preferably from 30 to 50 micro meters since the film exhibits even lower retardation.

According to a preferable embodiment of the invention, the second optical film 15 consists of the low-degree-substitution layer containing a cellulose acylate, fulfilling the condition of formula (1), as a main ingredient, or comprises the low-degree-substitution layer and a high-degree-substitution layer containing a cellulose acylate, fulfilling the condition of formula (2), as a main ingredient, disposed on at least one of the surfaces of the low-degree-substitution layer. If the second optical film 15 contains the low-degree substitution layer and fulfills the conditions of formulas (II′) and (IV′), it is possible to further reduce the color shift occurring in oblique directions when being observed in the black state by using the film fulfilling the conditions of the two formulas. More specifically, it is possible to further reduce Δv′, which is an indicator of the color shift, to a value of equal to or less than 0.8.

According to a more preferable embodiment of the invention, at least one of the outer protective films 16 and 17 consists of the low-degree-substitution layer containing a cellulose acylate, fulfilling the condition of formula (1), as a main ingredient, or comprises the low-degree-substitution layer and a high-degree-substitution layer containing a cellulose acylate, fulfilling the condition of formula (2), as a main ingredient, disposed on at least one of the surfaces of the low-degree-substitution layer. More preferably, both of them consist of the low-degree-substitution layer, or comprise the low-degree-substitution layer. If the outer protective film 16 and/or the outer protective film 17 contain the low-degree-substitution layer (more preferably, the thickness of the layer falls within the above-described range and the layer(s) fulfills the conditions of formulas (II′) and (IV′)), the circular-form unevenness may be reduced, which is preferable.

The term “the circular-form unevenness” means the circular-form unevenness of the brightness observed at the central portion of the displaying panel when the images are displayed on the panel. According to the embodiment in which the outer protective film 16 and/or the outer protective film 17 contains the low-degree-substitution layer, the circular-form unevenness may be reduced since the distance from the light-source is kept longer due to the thinner thickness of the film.

The details of the members which can be used in the invention will be described in detail.

### First and Second Optical Films:

The liquid crystal display device of the invention has the first and the second optical films fulfilling the conditions of formulas (I)-(IV), more preferably the conditions of formulas (I), (II′), (III) and (IV′).

0 nm≦Re(550)≦10 nm (I)

|Rth(550)|≦25 nm (II)

|Rth(550)|<10 nm (II′)

|Re(630)−Re(450)|≦10 nm (III)

|Rth(630)−Rth(450)|≦35 nm (IV)

5 nm≦|Rth(630)−Rth(450)|≦35 nm (IV′)

The first optical film (preferably and also the second optical film) consists of the low-degree-substitution layer containing a cellulose acylate, fulfilling the condition of formula (1), as a main ingredient, or comprises the low-degree-substitution layer and a high-degree-substitution layer containing a cellulose acylate, fulfilling the condition of formula (2), as a main ingredient, disposed on at least one of the surfaces of the low-degree-substitution layer.

2.0<Z1<2.7 (1)

Z1 represents a total substitution degree of the cellulose acylate used as the main ingredient of the layer with low degree of total acyl substitution.

2.7<Z2 (2)

Z2 represents a total substitution degree of the cellulose acylate used as the main ingredient of the outermost layer with high degree of total acyl substitution.

The thin film, fulfilling the conditions of formulas (II′) and (IV′), may be stably prepared by having the low-degree-substitution layer.

Here, the term “includes as a main component” means the cellulose acylate resin when one kind of cellulose acylate resin is used as a material of the cellulose acylate film, and means the cellulose acylate resin contained in a highest ratio when plural kinds of cellulose acylate resins are used as a material of the film.

The film, having the predetermined low-degree-substitution layer, which can be used in the invention as the first optical film, is referred to as “low-degree-substitution cellulose acylate film”, and will be described in detail below.

### (Cellulose Acylate)

The starting cellulose for cellulose acylate includes cotton linter, wood pulp (hardwood pulp, softwood pulp), etc.; and any cellulose acylate resin starting from any type of cellulose is usable herein, and as the case may be, plural types of cellulose acylate resins may be mixed for use here. The starting cellulose is described in detail, for example, in Marusawa & Uda's “Plastic Material Course (17), Cellulose Resin” by Nikkan Kogyo Shinbun (issued 1970), and Hatsumei Kyokai Disclosure Bulletin No. 2001-1745 (pp. 7-8); and various types of cellulose disclosed in these are usable here with no specific limitation thereon for use for the cellulose acylate film in the invention.

The starting cellulose acylate to be used for preparing the low-degree-substitution cellulose acylate film may have one type of acyl group or plural types of acyl groups. The cellulose acylate having one or more C₂₋₄ acyl groups are preferable. If the cellulose acylate having plural types of acyl groups is used, one of the acyl group is preferably an acetyl. As the C₂₋₄ acyl group, propionyl or butyryl is preferable. The cellulose acylates having such an acyl group may exhibit a good solubility, and a suitable solution to be used for preparing the film may be prepared by dissolving the cellulose acylates having such an acyl group in a solvent especially such as non-chlorine based solvent. Furthermore, the solution having a low viscosity and good-filtration property may be prepared.

A cellulose has free hydroxyl groups at 2-position, 3-position and 6-position per a unit of glucose having a β-1,4 bonding. Cellulose acylates are polymers obtained by acylation for a part or all of these hydroxyls. The degree of acyl-substitution means the total ratios of acylation for each of the 2-, 3- and 6-position-hydroxyls in a cellulose molecule. The degree of acyl-substitution is 1 when the ratio of acylation for each of the 2-, 3- and 6-position-hydroxyls is 100%.

Examples of the C₂ or longer acyl group include an aliphatic acyl group and an aryl acyl group. Examples of the cellulose acylate include alkyl carbonyl esters, alkenyl carbonyl esters, aromatic carbonyl esters, and aromatic alkyl carbonyl esters of cellulose, and they may have at least one substituent. Preferable examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, tert-butanoyl, cyclohexane carbonyl, oleoyl, benzoyl, naphthyl carbonyl, and cinnamoyl. Among these, acetyl, propionyl, butanoyl, dodecanoyl, octadecanoyl, tert-butanoyl, oleoyl, benzoyl, naphthyl carbonyl, and cinnamoyl are more preferable; acetyl, propionyl and butanoyl, each of which is C₂₋₄ acyl group, are even more preferable; and acetyl is especially preferable, or that is, cellulose acetate is especially preferable as the cellulose acylate.

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

According to the invention, the cellulose acylate to be used in preparing the layer with low degree of total acyl substitution of the low-substitution cellulose acylate film preferably fulfills the conditions of formulas (3) and (4) in terms of the wavelength dispersion characteristics of retardation.

1.0<X1<2.7 (3)

In formula (3), X1 represents a degree of acetylation of the cellulose acylate used as the main ingredient of the layer with low degree of total acyl substitution.

0≦Y1<1.5 (4)

In formula (4), Y1 represents a degree of acyl-substitution having 3 or more carbon atoms of the cellulose acylate used as the main ingredient of the layer with low degree of total acyl substitution.

It is to be noted that X1 and Y1 along with Z1 in formula (1) described above fulfill the condition of “X1+Y1=Z1”.

According to the invention, the cellulose acylate to be used in preparing the layer with low degree of total acyl substitution of the low-substitution cellulose acylate film preferably fulfills the conditions of formulas (6) and (7) in terms of the wavelength dispersion characteristics of retardation.

1.2<X2<3.0 (6)

In formula (6), X2 represents a degree of acetylation of the cellulose acylate used as the main ingredient of the outermost layer with high degree of total acyl substitution.

0≦Y2<1.5 (7)

In formula (7), Y2 represents a degree of acyl-substitution having 3 or more carbon atoms of the cellulose acylate used as the main ingredient of the outermost layer with high degree of total acyl substitution.

It is to be noted that X2 and Y2 along with Z2 in formula (2) described above fulfill the condition of “X2+Y2=Z2”.

The cellulose esters which can be used in the invention may be prepared according to the method described in JP-A-10-45804 or the like.

### (Non-Phosphate Ester Compound)

The low-substitution degree cellulose acylate film preferably contains at least one non-phosphate ester compound in the layer with low degree of total acyl substitution (more preferably in both of the low-substitution degree and the outermost layers with high degree of total acyl substitution). By adding such a non-phosphate ester compound, the film exhibiting low haze can be prepared.

In the specification, the term “non-phosphate ester compound” is used for any ester compounds in which the acid contributing to the ester bond is other than phosphoric acid, or, that is, the term “non-phosphate compound” means any ester compound not containing phosphoric acid.

The non-phosphate ester compound may be selected from low-molecular weight compounds or high-molecular weight compounds (polymers). The non-phosphate ester compound selected from polymers is occasionally referred to as “non-phosphate ester type polymer” hereinunder.

Preferably, in terms of lowering haze, the low-substitution degree cellulose acylate film contains at least one non-phosphate ester compound in both of the low-substitution degree and the high-degree substitution layers, and the ratio (the part by mass) of the non-phosphate ester compound in the high-degree substitution layer is smaller than the ratio (the part by mass) of the non-phosphate ester compound in the low-degree substitution layer. Next, the non-phosphate ester compound which can be used in the invention will be described in detail.

The non-phosphate ester compound may be selected from the high-molecular weight additives or the low-molecular weight additives. An amount of the additive with respect to the cellulose acylate is preferably from 1 to 35% by mass, more preferably from 4 to 30% by mass, or even more preferably from 10 to 25% by mass.

The high-molecular weight additive which can be used as the non-phosphate ester compound in the low-degree substitution cellulose acylate film is preferably selected from the polymers having a number-averaged molecular weight of from 700 to 10000. The polymer additive may have a function contributing to accelerating the volatilization rate of the solvent and lowering the content of the residual solvent in the solution casting method. The polymer additive may be effective in terms of improvement of the film properties such as the mechanical properties, the flexibility, the anti-water absorbability, and the anti-moisture permeability.

The number-averaged molecular weight of the polymer additive, which can be used as the non-phosphate ester compound, is preferably from 700 to 8000, more preferably from 700 to 5000, and even more preferably from 1000 to 5000.

Examples of the polymer additive, which can be used as the non-phosphate ester compound, include, but are not limited, those described in detail below. The non-phosphate ester compound is preferably selected from ester compounds other than phosphate.

Examples of the high-molecular-weight-additive, which is a non-phosphate compound, include polyester-type polymers such as aliphatic polyester-type polymers and aromatic polyester-type polymers, and any copolymers of polyester component(s) and other component(s); and preferable examples thereof include aliphatic polyester-type polymers, aromatic polyester-type polymers, copolymers of polyester-type polymers (e.g. aliphatic polyester-type polymers and aromatic polyester-type polymers) and acryl-type polymers, and copolymers of polyester-type polymers (e.g. aliphatic polyester-type polymers and aromatic polyester-type polymers) and styrene-type polymers. The copolymers in which at least one polyester component has an aromatic ring are more preferable.

The polyester-type polymers, which can be used in the invention, may be produced by reaction of a mixture of an aliphatic dicarboxylic acid having from 2 to 20 carbon atoms, and a diol selected from the group consisting of aliphatic diols having from 2 to 12 carbon atoms and alkyl ether diols having from 4 to 20 carbon atoms, and both ends of the reaction product may be as such, or may be blocked by further reaction with a monocarboxylic acid, a monoalcohol or a phenol. The terminal blocking may be effected for the reason that the absence of a free carboxylic acid in the polymer is effective for the storability thereof. The dicarboxylic acid for the polyester-type polymer is preferably a C₄₋₂₀ aliphatic dicarboxylic residue or a C₈₋₂₀ aromatic dicarboxylic residue.

The aliphatic dicarboxylic acids having from 2 to 20 carbon atoms preferably for use in the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

More preferred aliphatic dicarboxylic acids in these are malonic acid, succinic acid, maleic acid, fumaric acid, glutaric acid, adipic acid, azelaic acid, 1,4-cyclohexanedicarboxylic acid. Particularly preferred dicarboxylic acids are succinic acid, glutaric acid and adipic acid.

The diol used for the high-molecular-weight additive may be selected from aliphatic diols having from 2 to 20 carbon atoms and alkyl ether diols having from 4 to 20 carbon atoms.

Examples of the aliphatic diol having from 2 to 20 carbon atoms include alkyldiols and aliphatic diols, and more specifically include ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol(3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as any mixture.

Preferable examples of the aliphatic diol include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, and 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, and 1,4-cyclohexanedimethanol.

Preferable examples of the alkyl ether diol having from 4 to 20 carbon atoms include polytetramethylene ether glycol, polyethylene ether glycol and polypropylene ether glycol, and any combinations thereof. The average degree of polymerization is preferably, but not limited, from 2 to 20, more preferably 2 to 10, further preferably from 2 to 5, especially preferably from 2 to 4. Examples of the commercially-available typical polyether glycol include Carbowax resin, Pluronics resin and Niax resin.

Especially preferred is a high-molecular-weight additive of which the terminal is blocked with an alkyl group or an aromatic group. The terminal protection with a hydrophobic functional group is effective against aging at high temperature and high humidity, by which the hydrolysis of the ester group is delayed.

Preferably, the polyester additive is protected with a monoalcohol residue or a monocarboxylic acid residue in order that both ends of the polyester additive are not a carboxylic acid or a hydroxyl group.

In this case, the monoalcohol is preferably selected from substituted or unsubstituted monoalcohols having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, and oleyl alcohol; and substituted alcohols such as benzyl alcohol, and 3-phenylpropanol.

Examples of the alcohol, which is preferably used for terminal blocking, include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, and benzyl alcohol; and methanol, ethanol, propanol, isobutanol, cyclohexyl alcohol, 2-ethylhexyl alcohol, isononyl alcohol, and benzyl alcohol are preferable.

The monocarboxylic acid for use as the monocarboxylic acid residue in terminal blocking is preferably selected from substituted or non-substituted monocarboxylic acid having from 1 to 30 carbon atoms. It may be an aliphatic monocarboxylic acid or an aromatic monocarboxylic acid. Preferable examples of the aliphatic monocarboxylic acids include acetic acid, propionic acid, butanoic acid, caprylic acid, caproic acid, decanoic acid, dodecanoic acid, stearic acid, and oleic acid. Examples of the aromatic monocarboxylic acids include benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, and acetoxybenzoic acid. One or more of these may be used either singly or as combination thereof.

The polymer additive may be easily produced according to any of a thermal melt condensation method of polyesterification or interesterification of the dicarboxylic acid and diol and/or monocarboxylic acid or monoalcohol for terminal blocking, or according to an interfacial condensation method of an acid chloride of those acids and a glycol in an ordinary manner. The polyester additives are described in detail in “Additives, Their Theory and Application” (by Miyuki Publishing, first original edition published on Mar. 1, 1973, edited by Koichi Murai). The materials described in JP-A 05-155809, 05-155810, 05-197073, 2006-259494, 07-330670, 2006-342227, 2007-003679 are also usable in the invention.

The aromatic polyester-type polymers may be prepared by carrying out copolymerization of polyester polymer(s) and any monomer(s) having an aromatic group. The monomer having an aromatic group may be one or more selected from C₈₋₂₀ aromatic dicarboxylic acids and C₆₋₂₀ aromatic diols. Examples of the C₈₋₂₀ aromatic dicarboxylic acids include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid. Among these, preferable examples are phthalic acid, terephthalic acid and isophthalic acid.

Examples of the C₆₋₂₀ aromatic diol include, but are not limited, bisphenol A, 1,2-hydroxy benzene, 1,3-hydroxy benzene, 1,4-hydroxy benzene and 1,4-benzene dimethanol; and preferable are bisphenol A, 1,4-hydroxy benzene and 1,4-benzene dimethanol.

The aromatic polyester-type polymer may be any combinations of the above-described polyester(s) and at least one aromatic dicarboxylic acid or at least one aromatic diol, and any combinations containing two or more types of ingredients are usable. As described above, the polymer additives of which ends are blocked with an alkyl group or aromatic group are especially preferable. The method for blocking the ends may be carried out according to the above-described method.

### <Other Additives>

At least one additive other than the non-phosphate ester compound may be added to the low-degree substitution layer, and examples of the additive include retardation controllers (e.g. retardation enhancers and retardation reducers), plasticizers such as phthalates and phosphates, UV absorbers, antioxidants and matting agents.

According to the invention, the retardation reducer may be selected from any phosphoric acid type ester compounds or any known additives as an additive for a cellulose acylate film other than the non-phosphate ester compound.

The polymer retardation reducer is preferably selected from phosphate-polyester type polymers, styrene-type polymers, acryl-type polymers and any combinations thereof, and more preferably selected from acryl-type polymers and styrene-type polymers. At least one of the polymer retardation reducer is preferably selected from negative intrinsic birefringent polymers such as styrene-type and acryl-type polymers.

Examples of the compound other than the non-phosphate ester compound which can be used as the low-molecular weight retardation reducer include, but are not limited to, those described below. The low-molecular weight retardation reducer may be selected from solid or oily compounds. Namely, the low-molecular weight retardation reducer to be used in the invention is not limited in terms of the melting or boiling point. The mixture of UV absorbers having the melting point of not greater than 20 degrees Celsius and greater than 20 degrees Celsius respectively may be used, as well as the mixture of anti-degradation agents. Examples of the infrared absorber dye include those described in JP-A-2001-194522. The additive may be added to a cellulose acylate solution (dope) anytime in preparing the solution. Adding the additive to the cellulose acylate solution may be carried out as the final step in the preparation of the solution. An amount of each additive is not limited so far as obtaining its function.

Examples of the low-molecular weight retardation reducer other than non-phosphate ester compound include, but are not limited, those described in JP-A-2007-272177, [0066]-[0085].

The compounds, which are described in JP-A-2007-272177, [0066]-[0085], may be prepared according to the method described below.

The compound represented by formula (1) described in JP-A-2007-272177 may be prepared by a condensation reaction of a sulfonyl chloride derivative and an amine derivative.

The compound represented by formula (2) described in JP-A-2007-272177 may be prepared by a dehydration-condensation reaction of a carboxylic acid and an amine using a condensation agent such as dicyclohexylcarbodiimide (DCC), or by a substitution reaction of a carbonyl chloride derivative and an amine derivative.

Examples of the retardation reducer include Rth reducers. Among the above-described retardation reducers, acryl-type polymers, styrene-type polymers, and low-molecular weight compounds of formulas (3)-(7), described in JP-A-2007-272177, can be used as an Rth reducer. Among these, acryl-type and styrene-type polymers are preferable, and acryl-type polymers are more preferable.

An amount of the retardation reducer with respect to the cellulose acylate is preferably from 0.01 to 30% by mass, more preferably from 0.1 to 20% by mass, or even more preferably from 0.1 to 10% by mass.

When the amount is not greater than 30% by mass, it is possible to improve the compatibility with the cellulose acylate and to prevent from getting cloudy. When plural retardation reducers are used, a total amount thereof preferably falls within the above-described range.

### (Plasticizer)

Any compounds which have been known as a plasticizer in cellulose acylate films may be used in the invention. Examples of the plasticizer include phosphate esters and carboxylate esters. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetyl citrate (OACTE) and tributyl O-acetylcitrate (OACTB). Examples of other carboxylates include butyl oleate, methylacetyl ricinoleate, dibutyl sebacate, various trimellitates, etc. The phthalate-type plasticizers (DMP, DEP, DBP, DOP, DPP, DEHP) are preferably used here. DEP and DPP are especially preferred.

According to the invention, if necessary, other additive(s) such as an anti-degradation agent, UV absorber, peeling promoter, matting agent, lubricant and the above-described plasticizer may be used.

### (Anti-Degradation Agent)

At least one anti-degradation (antioxidant) agent may be added to the low-degree substitution cellulose acylate film, and examples thereof include phenol-type and hydroquinone-type antioxidant agents such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol) 2,5-di-tert-butyl hydroquinone, and pentaerythrityl tetrakis[3-(3,5-di-tert-butyl-4-hydroxyphenyl)propionate]. Also preferred are phosphonic acid-type antioxidants such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite and bis(2,4-di-tert-butylphenyl)pentaerythritol diphosphite. An amount of the anti-degradation agent to be added may be from 0.05 to 5.0 parts by mass relative to 100 parts by mass of the cellulose acylate.

### (UV Absorber)

The low-degree substitution cellulose acylate film may contain at least one UV absorber. The UV absorber is preferably selected from UV absorbers excellent in absorption ability for light having a wavelength of not longer than 370 nm, and having little absorption of light having a wavelength of not shorter than 400 nm, in terms of the good displaying characteristics. Preferred examples of the UV absorber for use in the invention include hindered phenol compounds, hydroxybenzophenone compounds, benzotriazole compounds, salicylate compounds, benzophenone compounds, cyanoacrylate compounds, and nickel complex compounds. Examples of the hindered phenol compound include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinn amide), 1,3,5-trimethyl-2,4,6-tris(3,5-di-tert-butyl-4-hydroxybenzyl) benzene, and tris-(3,5-di-tert-butyl-4-hydroxybenzyl)isocyanurate. Examples of the benzotriazole compound include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinn amide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, and pentaerythrityl tetrakis[3-(3,5-di-tert-butyl-4-hydroxyphenyl)propionate]. An amount of the UV absorbent to be added is preferably from 1 ppm to 1.0%, more preferably from 10 to 1000 ppm with respect to the total mass in the entire cellulose acylate laminate film.

### (Peeling Promoter)

Preferably, the low-degree substitution cellulose acylate film may contain a peeling promoter. The peeling promoter may be added to the film for the purpose of improving the peeling ability so as to be carried out more stably or more readily. The peeling promoter may be in the film, for example, in a ratio of from 0.001 to 1% by mass. Preferably, the content is at most 0.5% by mass since the releasing agent hardly separates from the film; and also preferably, the content is at least 0.005% by mass since a required release reduction effect may be realized. Accordingly, preferably, the content is from 0.005 to 0.5% by mass, more preferably from 0.01 to 0.3% by mass. The peeling promoter may be selected from any known peeling promoters such as organic and inorganic acid compounds, surfactants, and chelating agents. Above all, polycarboxylic acids and their esters are used effectively; and ethyl esters of citric acid are used more effectively.

In the embodiments of the low-degree substitution cellulose acylate film having the high-degree substitution layer, the high-degree substitution layer is preferably formed at the surface of the support such as a band, and the high-degree substitution layer preferably contains the peeling promoter.

### (Matting Agent)

In the low-degree substitution cellulose acylate film, at least one high-degree substitution layer preferably contains a matting agent from the view point of lubricity of the film and stable production. The matting agent may be selected from inorganic compounds or organic compounds.

Preferred examples of the inorganic matting agent include silicon-containing inorganic compounds such as silicon dioxide, calcined calcium silicate, hydrated calcium silicate, aluminium silicate and magnesium silicate, titanium oxide, zinc oxide, aluminium oxide, barium oxide, zirconium oxide, strontium oxide, antimony oxide, tin oxide, tin-antimony oxide, calcium carbonate, talc, clay, calcined kaolin, and calcium phosphate. More preferred are silicon-containing inorganic compounds and zirconium oxide. Particularly preferred is silicon dioxide since it can reduce haze of cellulose acylate films. As fine particles of silicon dioxide, commercially-available productions can be used, including, for example, AEROSIL R972, R972V, R974, R812, 200, 200V, 300, R202, OX50 and TT600 (all of them are manufactured by NIPPON AEROSIL CO., LTD.). As fine particles of zirconium oxide, for example, those in the market under trade names of AEROSIL R976 and R811 (manufactured by NIPPON AEROSIL CO., LTD.) can be used.

Preferable examples of the organic matting agent include polymers such as silicone resins, fluororesins, and acrylic resins. Above all, more preferred are silicone resins. Of silicone resins, even more preferred are those having a three-dimensional network structure. For example, usable are commercially-available products of Tospearl 103, Tospearl 105, Tospearl 18, Tospearl 120, Tospearl 145, Tospearl 3120 and Tospearl 240 (all trade names by Toshiba Silicone), etc.

The matting agent may be added to a cellulose acylate solution by any method so far as a desired cellulose acylate solution can be obtained without any problems. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called direct addition method, in which the ingredients may be on-line mixed by screw kneading. Concretely, preferred is a static mixer such as an in-line mixer. As the in-line mixer, for example, preferred is a static mixer, SWJ (Toray's static tubular mixer, Hi-Mixer, by Toray Engineering). Regarding the mode of in-line addition, JP-A 2003-053752 describes an invention of a method for producing a cellulose acylate film wherein, for the purpose of preventing concentration unevenness and particle aggregation, the distance L between the nozzle tip through which an additive liquid having a composition differing from that of the main material dope and the start end of an in-line mixer is controlled to be at most 5 times the inner diameter d of the main material feeding line, thereby preventing concentration unevenness and aggregation of matting particles, etc. The patent reference discloses a more preferred embodiment, in which the distance (L) between the nozzle tip opening through which an additive liquid having a composition differing from that of the main material dope and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, the patent reference discloses that the flow ratio of the cellulose acylate film main material dope/in-line additive liquid is from 10/1 to 500/1, more preferably from 50/1 to 200/1. JP-A 2003-014933 discloses an invention of providing a retardation film which is free from a trouble of additive bleeding and a trouble of interlayer peeling and which has good lubricity and excellent transparency; and regarding the method of adding additives to the film, the patent reference says that the additive may be added to a dissolving tank, or the additive or a solution or dispersion of the additive may be added to the dope being fed in the process from the dissolving tank to a co-casting die, further describing that in the latter case, mixing means such as a static mixer is preferably provided for the purpose of enhancing the mixing efficiency therein.

When the film of the invention has a structure of skin A/core/skin B, the film preferably contains a matting agent in at least one of the skin A layer and the skin B layer for the purpose of enhancing the scratch resistance of the film by reducing the friction coefficient on the film surface, and for the purpose of preventing the film that is wide and long from being creaked and folded while it is rolled up. More preferably, a matting agent is added to both the skin A layer and the skin B layer of the film for the purpose of more effectively enhancing the scratch resistance of the film and preventing the film from being creaked.

The matting agent may be added to a cellulose acylate solution according to any method so far as desired cellulose acylate solution can be obtained without any problems. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called imminent addition method, in which the ingredients may be on-line mixed by screw kneading. Concretely, preferred is a static mixer such as an in-line mixer. As the in-line mixer, for example, preferred is a static mixer, SWJ (A static tubular mixer, Hi-Mixer, by Toray Engineering). Regarding the mode of in-line addition, JP-A 2003-053752 describes an invention of a method for producing a cellulose acylate film wherein, for the purpose of preventing concentration unevenness and particle aggregation, the distance L between the nozzle tip through which an additive liquid having a composition differing from that of the main material dope and the start end of an in-line mixer is controlled to be at most 5 times the inner diameter d of the main material feeding line, thereby preventing concentration unevenness and aggregation of matting particles, etc. JP-A 2003-053752 discloses a more preferable embodiment, in which the distance (L) between the nozzle tip opening through which an additive liquid having a composition differing from that of the main material dope and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, JP-A 2003-053752 discloses that the flow ratio of the cellulose acylate film main material dope/in-line additive liquid is from 10/1 to 500/1, more preferably from 50/1 to 200/1. JP-A 2003-014933 discloses an invention of providing a retardation film which is free from a trouble of additive bleeding and a trouble of interlayer peeling and which has good lubricity and excellent transparency; and regarding the method of adding additives to the film, the patent reference says that the additive may be added to a dissolving tank, or the additive or a solution or dispersion of the additive may be added to the dope being fed in the process from the dissolving tank to a co-casting die, further describing that in the latter case, mixing means such as a static mixer is preferably provided for the purpose of enhancing the mixing efficiency therein.

In a preferable embodiment, the low-degree substitution cellulose acylate film has the low-degree substitution layer as a core layer, and the high-degree substitution layer disposed on each of the surfaces of the low-degree substitution layer; more preferably, at least one of the high-degree substitution layer contains the matting agent, in terms of improving the abrasion-resistant properties caused by reducing the friction coefficient of the film surface, or in terms of preventing the wide-long film from straining or cracking while being wound-up; or even more preferably, both of the high-degree substitution layers contain the matting agent, in terms of improving the abrasion-resistance, or in terms of preventing the straining.

In the low-degree substitution cellulose acylate film, the matting agent does not increase the haze of the film so far as a large amount of the agent is not added to the film. When the film containing a suitable amount of a matting agent is actually used in LCD, the film may not suffer from disadvantages such as the low contrast and the bright spots. Not too small amount of the matting agent in the film may achieve the prevention of the cracking and the improvement of the abrasion-resistance. From these viewpoints, an amount of the matting agent is preferably from 0.01 to 5.0% by mass, more preferably from 0.03 to 3.0% by mass, even more preferably from 0.05 to 1.0% by mass.

### (Haze)

The low-degree substitution cellulose acylate film preferably has a haze of less than 0.20%, more preferably less than 0.15%, particularly preferably less than 0.10%. Having a haze of less than 0.20%, the film can improve contrast ratio of a liquid crystal display device incorporating it and the transparency of the film is enough high to use as an optical film.

In a preferable embodiment, the low-degree substitution cellulose acylate film has the low-degree substitution layer as a core layer, and the high-degree substitution layer disposed on at least one of the surfaces of the low-degree substitution layer. A single type of the cellulose acylate having the uniform degree of the acylation or plural types of the cellulose acylates having the different degrees of the acylation may be contained in each of the layers. Preferably, the degree of the acylation of the cellulose acylate contained in each of the layers is uniform, in terms of adjusting the optical properties.

In case where the low-degree substitution cellulose acylate film is produced according to a solution casting method, preferably, the layer in contact with the support (hereinafter this may be referred to as a skin B layer) is the high-degree substitution layer and the other layer is the low-degree substitution layer, from the viewpoint of improving the releasability of the film from the support in the solution casting method.

Preferably, the low-degree substitution cellulose acylate film has a three or more multi-layered laminate structure, in terms of the dimensional stability or in terms of reducing the curling caused by an environmental humidity/temperature variation. Also preferably, the high-degree substitution layer is on both surfaces of the low-degree substitution layer in terms of broadening the latitude in the step of achieving the desired optical properties to be required for the first film. More preferably, the film of the invention has a three or more multi-layered laminate structure, in which all the cellulose acylate contained in at least one internal layer is the cellulose acylate fulfilling the conditions of the above formulas (3) and (4), and all the cellulose acylate contained in the two surface layers is the cellulose acylate fulfilling the conditions of the above formulas (5) and (6). Only in the embodiments having a three or more multi-layered laminate structure, the surface layer not in contact with the support in the film formation is occasionally referred to as a skin A layer.

Preferably, the low-degree substitution cellulose acylate film has a three-layered structure of skin B layer/core layer/skin A layer. The low-degree substitution cellulose acylate film having a three-layered structure may have a constitution of high-degree substitution layer/low-degree substitution layer/high-degree substitution layer, or a constitution of low-degree substitution layer/high-degree substitution layer/low-degree substitution layer; but preferably, the film has a constitution of high-degree substitution layer/low-degree substitution layer/high-degree substitution layer in terms of the releasability of the film from the support in solution-casting film formation and in terms of the dimensional stability of the film.

In the low-degree substitution cellulose acylate film having a three-layered structure, preferably, the cellulose acylate to be in both surface layers is one having the same degree of acyl substitution in terms of the production cost and the dimensional stability of the film and in the terms of reducing the curling of the film caused by an environmental humidity/heat variation.

### (Film Thickness)

Preferably, the mean thickness of the low-degree substitution layer of the low-degree substitution cellulose acylate film is from 30 to 100 micro meters, more preferably from 30 to 80 micro meters, even more preferably from 30 to 70 micro meters. When the low-degree substitution layer has a mean thickness of equal to or more than 30 micro meters, the handlability of the film is improved, which is preferable. When the low-degree substitution layer has a mean thickness of equal to or less than 70 micro meters, the film may readily follow the ambient humidity variation and may keep its optical properties.

In the low-degree substitution cellulose acylate film, the mean thickness of at least one high-degree substitution layer is preferably from 0.2% to less than 25% of the mean thickness of the low-degree substitution layer. When it is equal to or more than 0.2%, the peeling abilities of the film may be sufficient, and the film may not suffer from streaky surface unevenness, thickness unevenness and uneven optical properties of the film; and when it is less than 25%, the optical properties of the low-degree substitution layer may be effectively used and the film may achieve sufficient optical properties. The mean thickness of at least one high-degree substitution layer is more preferably from 0.5 to 15% of the mean thickness of the low-degree substitution layer, even more preferably from 1.0 to 10% of the mean thickness of the low-degree substitution layer. Still more preferably, the mean thickness of both the skin layers A and B are from 0.2% to less than 25% of the mean thickness of the core layer.

Preferably, in the low-degree substitution cellulose acylate film, the mean thickness of the low-degree substitution layer is from 30 to 100 micro meters, and the mean thickness of at least one high-degree substitution layer is from 0.2% to less than 25% of the mean thickness of the low-degree substitution layer, in terms of the wavelength dispersion characteristics of retardation of the film. More preferably, the mean thickness of the low-degree substitution layer is from 30 to 100 micro meters, and the mean thicknesses of both high-degree substitution layers are from 0.2% to less than 25% of the mean thickness of the low-degree substitution layer.

In the embodiments in which the low-degree substitution cellulose acylate film has a three or more multi-layered structure, preferably, the thickness of the low-degree substitution layer (preferably, the thickness of the core layer) is from 30 to 70 micro meters, more preferably from 30 to 60 micro meters, even more preferably from 30 to 50 micro meters.

In the embodiments in which the low-degree substitution cellulose acylate film has a three or more multi-layered structure, preferably, the thickness of the high-degree substitution layer (preferably, the thickness of the surface layer on both sides of the film) is from 0.5 to 20 micro meters, more preferably from 0.5 to 10 micro meters, even more preferably from 0.5 to 3 micro meters.

The low-degree substitution cellulose acylate film may have a three-layered laminate structure, in which the inner layer (core layer) may be the above-mentioned low-degree substitution layer and the surface layers (skin B layer and skin A layer) may be the above-mentioned high-degree substitution layers. Preferably, the thicknesses of the skin B layer and the skin A layer are smaller than that of the core layer. The preferable condition of the thickness of the surface layer may be the same as that in the low-degree substitution cellulose acylate film having a three or more multi-layered structure.

### (Film Width)

The film width of the low-substitution degree cellulose acylate film is preferably from 700 to 3000 mm, more preferably from 1000 to 2800 mm, particularly preferably from 1500 to 2500 mm.

The low-degree substitution cellulose acylate film also preferably has the film width of from 700 to 3000 mm and ΔRe of equal to or less than 10 nm.

### [Method for Producing Low-Degree Substitution Cellulose Acylate Film]

One example of the method for producing the low-degree substitution cellulose acylate film comprises

a step of forming a cellulose acylate laminate film by sequential casting or simultaneous co-casting of a cellulose acylate solution for low-degree substitution layer that contains a cellulose acylate fulfilling the condition of formula (1) and, if desired, a non-phosphate ester compound, and a cellulose acylate solution for high-degree substitution layer that contains a cellulose acylate fulfilling the condition of formula (2), and

a step of stretching the cellulose acylate laminate film at a temperature of from 100 to 250 degrees Celsius along the transverse direction (TD) while the end of the machine direction (MD) is kept as the fixed end (the stretching carried out in this step is occasionally referred to as “TD stretching”).

Preferably, the cellulose acylate laminate film is formed according to a solvent casting method. For production examples for cellulose acylate film according to a solvent casting method, referred to are U.S. Pat. Nos. 2,336,310, 2,367,603, 2,492,078, 2,492,977, 2,492,978, 2,607,704, 2,739,069 and 2,739,070, British Patents 640731 and 736892, JP-B 45-4554 and 49-5614, JP-A 60-176834, 60-203430 and 62-115035. The cellulose acylate film may be stretched. For the method and the condition for stretching treatment, referred to are, for example, JP-A 62-115035, 4-152125, 4-284211, 4-298310, 11-48271.

Examples of the solution casting method include a method of uniformly extruding a prepared dope through a pressure die onto a metal support, a doctor blade method of regulating the thickness of the dope once cast on a metal support, with a blade, and a method with a reverse roll coater of regulating the thickness with a reverse-rotating roll. Preferred is the method with a pressure die. Examples of the pressure die include a coat hanger-type die, and a T-die. Any of these is favorably used herein. Apart from the methods mentioned herein, any other various known methods of forming a cellulose triacetate solution into films are also employable. In consideration of the difference in the boiling point of the solvent to be used, the conditions may be set, and the same advantages as in the reference publications can be attained here.

The low-degree substitution film is produced in a process comprising a step of forming a film by applying the cellulose acylate solution (casting dope) for low-degree substitution layer that contains a cellulose acylate fulfilling the condition of formula (1) and, if desired, a non-phosphate ester compound, and the cellulose acylate solution for high-degree substitution layer that contains a cellulose acylate fulfilling the condition of formula (2) onto a support, and a step of stretching the resulting film.

In the production method, preferably, the viscosity at 25 degrees Celsisu of the cellulose acylate solution for low-degree substitution layer is higher by at least 10% than the viscosity at 25 degrees Celsius of the cellulose acylate solution for high-degree substitution layer, in terms of the transversal distribution of the laminate film layers and in terms of the aptitude for production of the laminate film.

For preparing the low-degree substitution cellulose acylate film, a laminate casting method such as a co-casting method, a sequential casting method, and a coating method are preferably used. A simultaneous co-casting method is more preferable in terms of improving the stability of production and reducing the production cost.

In the embodiments where the low-degree substitution cellulose acylate film is prepared according to a co-casting method or a sequential casting method, at first, a cellulose acetate solution (dope) for each layer is prepared. In the co-casting method (superimposition simultaneous casting), casting dopes to be the constitutive layers (three or more layers) are extruded out through a casting T-die of simultaneously extruding the dopes through the respective slits onto a casting support (band or drum), and simultaneously cast thereon, and then peeled off from the support at a suitable time to give a film. FIG. 2 is a cross-sectional view showing the condition of simultaneous extrusion and casting of a surface layer dope 1 and core layer dopes 2 onto a casting support 4 through a co-casting T-die 3, thereby forming three layers on the support.

In the sequential casting method, a casting dope for the first layer is first extruded out and cast through a casting T-die onto a casting support, and after it is dried or not, a casting dope for the second layer is extruded out and cast onto it through a casting T-die, and in that manner, if desired, other dope(s) are cast and laminated on the previous layer up to be three (or more) layers, and at a suitable time, the resulting laminate is peeled off from the support and dried to be a film. In the coating method, in general, a film of the core layer is formed according to a solution casting method, then a coating liquid to be the surface layer is prepared, and using a suitable coating unit, the coating liquid is applied onto the core film on one side thereof at a time or on both sides simultaneously, and dried to give a laminate-structured film.

As the endlessly running metal support for use in producing the film of the invention, usable is a drum of which the surface is mirror-finished by chromium plating, or a stainless belt (band) of which the surface is mirror-finished by polishing. One or more pressure dies may be arranged above the metal support. Preferably, one or two pressure dies are arranged. In case where two or more pressure dies are arranged, the dope to be cast may be divided into portions suitable for the individual dies; or the dope may be fed to the die at a suitable proportion via a plurality of precision metering gear pumps. The temperature of the cellulose acylate solution to be case is preferably from −10 to 55 degrees Celsius, more preferably from 25 to 50 degrees Celsius. In this case, the solution temperature may be the same throughout the entire process, or may differ in different sites of the process. In case where the temperature differs in different sites, the dope shall have the desired temperature just before cast.

The above-described stretching treatment makes it possible to impart the optical properties, which are required for the first optical film to have, to the stretched film. The stretching direction of the cellulose acylate film may be along the machine direction or along the direction (the transverse direction) perpendicular to the machine direction. More preferably, the film is stretched along the direction (the transverse direction) perpendicular to the machine direction, in terms of the subsequent process of using the film for producing a polarizer.

The method of stretching along the transverse direction is described, for example, in JP-A 62-115035, 4-152125, 4-284211, 4-298310, 11-48271. For the machine direction stretching, for example, the speed of the film conveyor rollers is regulated so that the film winding speed could be higher than the film peeling speed whereby the film may be stretched. For the transverse direction stretching, the film is conveyed while held by a tenter at the sides thereof and the tenter width is gradually broadened, whereby the film can be stretched. After dried, the film may be stretched with a stretcher (preferably for monoaxial stretching with a long stretcher).

The stretching ratio of the low-degree substitution cellulose acylate film is preferably from 5% to 200%, more preferably from 10% to 100%, or even more preferably from 20% to 50%.

In the embodiments where the first optical film of the low-degree substitution cellulose acylate film is used as a protective film of a polarizing element, preferably, the low-degree substitution cellulose acylate film is disposed so that the in-plane slow axis of the low-degree substitution cellulose acylate film is parallel to the transmission axis of the polarizing element, in terms of preventing the light leakage when the polarizing plate is observed in oblique directions. The transmission axis of the roll film-type polarizing element, which is prepared continuously, is generally parallel to the transverse direction of the roll film-type polarizing element, and so, in continuously uniting the roll film-type polarizing element and a roll film-type protective film, which is the cellulose acylate film, the in-plane slow axis of the roll film-type protective film is preferably parallel to the transverse direction thereof. Accordingly, the film is preferably stretched with a larger ratio along the transverse direction. The stretching treatment may be carried out during the film formation process, or the stretching treatment may be carried out after the film is wound-up. In the above-described production method, the film is preferably stretched during the film formation process since it contains the residual solvent therein.

Preferably, the production method preferably further comprises a step of drying the low-degree substitution cellulose acylate film after the stretching step, and a step of stretching the dried cellulose acylate laminate film at a temperature of equal to or higher than Tg-10 degrees Celsius, in terms of enhancing the retardation of the film.

For drying the dope on a metal support in production of the low-degree substitution cellulose acylate film, generally employable is a method of applying hot air to the surface of the metal support (drum or belt), or that is, on the surface of the web on the metal support; a method of applying hot air to the back of the drum or belt; or a back side liquid heat transfer method that comprises contacting a temperature-controlled liquid with the opposite side of the dope-cast surface of the belt or drum, or that is, the back of the belt or drum to thereby heat the belt or drum by heat transmission to control the surface temperature thereof. Preferred is the backside liquid heat transfer method. The surface temperature of the metal support before the dope is cast thereon may be any degree so far as it is not higher than the boiling point of the solvent used in the dope. However, for promoting the drying or for making the dope lose its flowability on the metal support, preferably, the temperature is set to be lower by from 1 to 10 degrees Celsius than the boiling point of the solvent having the lowest boiling point of all the solvents in the dope. In case where the cast dope is peeled off after cooled but not dried, then this shall not apply thereto.

For controlling the thickness of the film, the solid concentration in the dope, The slit gap of the die nozzle, the extrusion pressure from the die, and the metal support speed may be suitably regulated so that the formed film could have a desired thickness.

Produced in the manner as above, the length of the low-degree substitution cellulose acylate film is preferably from 100 to 10000 m per roll, more preferably from 500 to 7000 m, even more preferably from 1000 to 6000 m. In rolling up the film, preferably, at least one edge thereof is knurled, and the knurling width is preferably from 3 mm to 50 mm, more preferably from 5 mm to 30 mm, and the knurling height is preferably from 0.5 to 500 micro meters, more preferably from 1 to 200 micro meters. This may be one-way or double-way knurling.

The thickness of the low-degree substitution cellulose acylate film is not limited, and the thinner film is more preferable in terms of lower retardation. Specifically, the thickness of the low-degree substitution cellulose acylate film is preferably from 30 to 130 micro meters, or more preferably from 30 to 50 micro meters.

The liquid crystal display device of the invention further comprises the second optical film fulfilling the conditions of formulas (I)-(IV). The second optical film is not limited in terms of its material so far as the film fulfills the conditions of formulas (I)-(IV). The cellulose acylate films described in JP-A-2006-227606 may be used as the second optical film. Cyclic olefin based polymer films, polyvinyl alcohol films, polypropylene films, polycarbonate films, norbornene based films, acryl based films, and PET films may be also used as the second optical film. According to the invention, the low-degree substitution cellulose acylate film is preferably also used as the second optical film.

The first and the second optical films are preferably disposed as the inner protective film, which is disposed between the liquid crystal cell and the polarizing element, of the polarizing element. Namely, preferably, only an adhesive layer is disposed between the first polarizing element and the first optical layer, or between the second polarizing element and the second optical film; and preferably, any retardation layer, which may influence the optical compensation, is not disposed between the first polarizing element and the first optical layer, or between the second polarizing element and the second optical film.

### First and Second Polarizing Elements:

According to the invention, the first and the second polarizing elements are not limited. The linear polarizing film may be selected from coating-type polarizing films as typified by Optiva Inc., iodine-based polarizing films and dichroic-dye based polarizing films. Iodine or dichroic dye molecules are oriented in binder so as to have a polarizing capability. Iodine or dichroic dye molecules may be oriented along with binder molecules, or iodine molecules may aggregate themselves in the same manner of liquid crystal and be aligned in a direction. Generally, commercially available polarizing films are produced by soaking a stretched polymer film in a solution of iodine or dichroic dye and impregnating the polymer film with molecules of iodine or dichroic dye.

### Outer Protective Film:

The liquid crystal display device preferably comprises the outer protective film disposed at the outside each of the first and the second polarizing elements. The outer protective film to be used in the invention is not limited. Cellulose acetate films, cyclic olefin based polymer films, polyvinyl alcohol films, polypropylene films, polycarbonate films, norbornene based films, acryl based films, and PET films may be used as the outer protective film. The commercially available cellulose acetate films such as “TD80UL” manufactured by FUJIFILM may also be used.

Preferably, at least one of the outer protective films is the low-degree substitution cellulose acylate film, in terms of reducing the circular-form unevenness.

### IPS or FFS Mode Liquid Crystal Cell:

The IPS or FFS mode liquid crystal cell which can be used in the invention is not limited in terms of the constitution. Any constitutions of the IPS or FFS mode may be used.

According to the IPS mode, the liquid crystal molecules are switched so as to always align horizontally with respect to the substrates, and the liquid crystal molecules are switched by a transverse electric field parallel to the substrates. The configuration of the electrode may be a line-like, network-like, spiral-like, dot-like, or zig-zag-like configuration. The preferable value of Δnd may be about 300 nm.

As well as the IPS mode, according to the FFS mode, the liquid crystal molecules are switched so as to always align horizontally with respect to the substrates, and the liquid crystal molecules are switched by a transverse electric field parallel to the substrates. Usually, an FFS mode liquid crystal display device comprises a solid electrode, an interlayer insulating film and a comb-like electrode, and according to the FFS mode, the electric field is applied in a direction different from that according to the IPS mode. The preferable value of Δnd may be about 350 nm.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### 1. Examples of Preparing Cellulose Acylate Films

### (Preparation of Cellulose Acylate)

According to the method described in JP-A 10-45804 and 08-231761, a cellulose acylate was produced, and its degree of substitution was measured. Concretely, as a catalyst, sulfuric acid was added in an amount of 7.8 parts by mass relative to 100 parts by mass of cellulose, and a carboxylic acid as a material for the acyl group was added for acylation at 40 degrees Celsius. In this process, the type and the amount of the carboxylic acid were controlled to thereby control the type and the degree of acyl substitution. After the acylation, the product was ripened at 40 degrees Celsius. The low-molecular-weight ingredient of the cellulose acylate was washed away with acetone.

### (Preparation of Cellulose Acylate Solutions “C01” to “C09” for Low-Substitution Layer)

The following composition was put into a mixing tank and stirred to dissolve the ingredients, thereby preparing a cellulose acylate solution. The amount of the solvent (methylene chloride and methanol) was suitably controlled so that the concentration of the solid content in the cellulose acylate solution could be as in Table 1 below.

| | |
|---|---|
| Cellulose Acetate shown in the following table | 100.0 parts by mass |
| Additive shown in the following table | an amount shown in the |
| | following table |
| Methylene chloride | 365.5 parts by mass |
| Methanol | 54.6 parts by mass |

The other cellulose acylate solutions for low-substitution layer were prepared in the same manner as that for “C01”, except that the degree of acetyl substitution of cellulose acetate, and the amount and the type of the additive were changed as shown in Table 1 below. The concentrations of the solid content of the thus-obtained cellulose acylate solutions for low-substitution layer are shown in Table 1 below.

TABLE 1

| | Cellulose Acetate | | Additive | | Concentration |
|---|---|---|---|---|---|
| | | Amount | | Amount | of Solid |
| Solution | Degree of | (Parts | | (Parts | Content |
| No. | Substitution | by mass) | Compound | by mass) | (% by mass) |
| C01 | 2.45 | 100 | A*1 | 30 | 24 |
| C02 | 2.65 | 100 | A*1 | 30 | 24 |
| C03 | 2.45 | 100 | A*1 | 40 | 25 |
| C04 | 2.45 | 100 | B*2 | 30 | 24 |
| C05 | 2.45 | 100 | C*3 | 30 | 24 |
| C06 | 2.45 | 100 | D*4 | 30 | 24 |
| C07 | 2.45 | 100 | E*5 | 30 | 24 |
| C08 | 2.45 | 100 | F*6 | 40 | 25 |
| C09 | 2.94 | 100 | G*7 | 16 | 22 |

*1Compound A is a copolymer of terephthalic acid/succinic acid/propylene glycol/ethylene glycol (copolymerization ratio = 27.5/22.5/25/25 [mol. %]).
*2Compound B is a copolymer of terephthalic acid/phthalic acid/adipic acid/succinic acid/ethylene glycol (copolymerization ratio = 22.5/2.5/10/15/50 [mol. %]).
*3Compound C is a copolymer of terephthalic acid/phthalic acid/adipic acid//ethylene glycol (copolymerization ratio = 22.5/2.5/25/50 [mol. %]).
*4Compound D is a copolymer of adipic acid/succinic acid/ethylene glycol (copolymerization ratio = 25/25/50 [mol. %]).
*5Compound E is a copolymer of terephthalic acid/phthalic acid/succinic acid/propylene glycol/ethylene glycol (copolymerization ratio = 22.5/2.5/25/37.5/12.5 [mol. %]).
*6Compound F is para-hydroxy styrene (PHS) manufactured by TOHO Chemical Industry Co., LTD.
*7Compound G is Compound (A-19) represented by the following formula which is described in Japanese Patent No. 4055861.

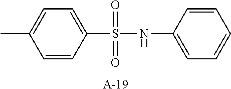

### (Preparation of Cellulose Acylate Solutions “S01” to “S06” for High-Substitution Layer)

The composition having the following formulation was put into a mixing tank and stirred to dissolve the ingredients, thereby preparing a cellulose acylate solution. The amount of the solvent (methylene chloride and methanol) was suitably controlled so that the concentration of the solid content in the cellulose acylate solution could be as shown in Table 2 below.

| | |
|---|---|
| Cellulose acetate (the degree of substitution is 2.81) | 100.0 parts by mass |
| Additive shown in the following table | an amount shown in |
| | the following table |
| Silica fine particles R972 (by Nippon Aerosil) | 0.15 part by mass |
| Methylene chloride | 395.0 parts by mass |
| Methanol | 59.0 parts by mass |

The other cellulose acylate solutions for high-substitution layer were prepared in the same manner as that for “S01”, except that the degree of substitution of cellulose acetate, and the amount and the type of the additive were changed as shown in Table 2 below. The concentrations of the solid content of the thus-obtained cellulose acylate solutions for high-substitution layer are shown in Table 2 below.

TABLE 2

| | Cellulose acetate | | Additive | | Silica | Concentration |
|---|---|---|---|---|---|---|
| | | Amount | | Amount | Fine Particles | of |
| Solution | Degree of | (Parts | | (Parts | (Parts | Solid Content |
| No. | Substitution | by mass) | Compound | by mass) | by mass) | (% by mass) |
| S01 | 2.81 | 100 | A | 11 | 0.15 | 20 |
| S02 | 2.81 | 100 | B | 11 | 0.15 | 20 |
| S03 | 2.81 | 100 | C | 11 | 0.15 | 20 |
| S04 | 2.81 | 100 | D | 11 | 0.15 | 20 |
| S05 | 2.81 | 100 | E | 11 | 0.15 | 20 |
| S06 | 2.81 | 100 | F | 11 | 0.15 | 20 |

### (Preparation of Cellulose Acylate Films)

For preparing each of Films 1-10, the cellulose acylate solution for low-substitution layer was cast to give a core layer having the thickness shown in the following table, and the cellulose acylate solution for high-substitution layer was to give a skin A layer and a skin B layer each having the thickness shown in the following table.

The obtained web (film) was peeled off from the band, and, after being dried, rolled up. At that time, the residual solvent amount in each of the films was from 0 to 0.5% with respect to the total mass of the film. Subsequently, the film was fed, and was subjected to a TD stretching treatment under the conditions shown in the following table by a tenter.

The residual solvent amount was computed according to the following formula:

Residual Solvent Amount (% by mass)={(M−N)/N}×100

In the formula, M is the mass of wet at an indefinite time, N is the mass of the web dried at 120 degrees Celsius for 2 hours after its M was measured

| | | | | | | | Conditions of | |
|---|---|---|---|---|---|---|---|---|
| | Core Layer | | Skin A Layer | | Skin B Layer | | Stretching | |
| Sample | | Thickness | | Thickness | | Thickness | Temperature | Ratio |
| No. | Solution | (μm) | Solution | (μm) | Solution | (μm) | (° C.) | (%) |
| Film 1 | C01 | 56 | S01 | 2 | S01 | 2 | 210 | 2 |
| Film 2 | C02 | 56 | S01 | 2 | S01 | 2 | 200 | 2 |
| Film 3 | C03 | 36 | S01 | 2 | S01 | 2 | 200 | 2 |
| Film 4 | C04 | 36 | S01 | 2 | S01 | 2 | 190 | 10 |
| Film 5 | C04 | 36 | S02 | 2 | S02 | 2 | 200 | 2 |
| Film 6 | C05 | 36 | S03 | 2 | S03 | 2 | 200 | 2 |
| Film 7 | C06 | 36 | S04 | 2 | S04 | 2 | 200 | 2 |
| Film 8 | C07 | 36 | S05 | 2 | S05 | 2 | 200 | 2 |
| Film 9 | C08 | 56 | S06 | 2 | S06 | 2 | 200 | 20 |
| Film 10 | C09 | 80 | — | — | — | — | 100 | 6 |

The optical properties of the prepared films, Films 1-10, are shown in the following table.

| | | | | | Rth(630)- |
|---|---|---|---|---|---|
| Sample | Thickness | Re(550) | Re(630)-Re(450) | Rth(550) | Rth(450) |
| No. | (μm) | (nm) | (nm) | (nm) | (nm) |
| Film 1 | 60 | 1 | 1 | −5 | 10 |
| Film 2 | 60 | 1 | 1 | −5 | 10 |
| Film 3 | 40 | 0.7 | 1 | −3 | 7 |
| Film 4 | 60 | 15 | 1 | 45 | 10 |
| Film 5 | 40 | 0.5 | 1 | −2 | 6 |
| Film 6 | 40 | 0.7 | 1 | −3 | 7 |
| Film 7 | 40 | 0.7 | 1 | −5 | 6 |
| Film 8 | 40 | 0.7 | 1 | −4 | 8 |
| Film 9 | 60 | 1 | 15 | −5 | 45 |
| Film 10 | 80 | 1 | −1 | −10 | 5 |

### 2. Examples of Preparing Polarizing Plates

Each of the prepared cellulose acylate films (Films 1-10), and a film of TD80UL (by FUJIFILM) were united so that a polarizing film was sandwiched between them and disposed on the surfaces of the linear polarizing film respectively. Regarding Films 1, 3 and 5-9, two films in combination shown in the following table was united so that a linear polarizing film was sandwiched between them. In this way, polarizing plates were prepared. In these, the linear polarizing film and each of Films 1-10 were united so that the absorption axis of the linear polarizing film was perpendicular to the slow axis of each of Films 1-10, and the linear polarizing film and TD80UL were united so that the absorption axis of the linear polarizing film was parallel to the slow axis of TD80UL. The surface of each of the films to be attached was subjected to an alkali saponification. The linear polarizing film was prepared as follows. A polyvinyl alcohol, having a thickness of 80 micro meters, was continuously stretched by 5 times in an aqueous iodine solution, and dried. The obtained linear polarizing film, having the thickness of 20 micro meters, was used. And as an adhesive, a 3% aqueous solution of polyvinyl alcohol (“PVA-117” by Kuraray Co., Ltd.) was used.

### 3. Examples of Preparing Liquid Crystal Display Devices and Evaluations of Liquid Crystal Display Devices

### (1) Fabrication of IPS-mode Liquid Crystal Display Device

The polarizing plates were removed from a liquid crystal TV (“37Z3500” by TOSHIBA), and, in place of them, two of the prepared polarizing plates were united thereinto so that they were disposed in a cross-Nicol configuration. The backlight-side polarizing plate was disposed so that the absorption axis of the backlight-side polarizing plate was parallel to the slow axis of the liquid crystal cell.

Each of the IPS-mode liquid crystal display devices having the configuration shown in the following table was fabricated.

### (2) Fabrication of FFS-mode Liquid Crystal Display Device

The polarizing plates were removed from a liquid crystal TV (“37H3000” by TOSHIBA), and, in place of them, two of the prepared polarizing plates were united thereinto so that they were disposed in a cross-Nicol configuration. The observer-side polarizing plate was disposed so that the absorption axis of the observer-side polarizing plate was parallel to the slow axis of the liquid crystal cell.

Each of the FFS-mode liquid crystal display devices having the configuration shown in the following table was fabricated.

### (3) Evaluations of Liquid Crystal Display Devices

### (Evaluation of Color Shift)

For each of the IPS and FFS mode liquid crystal display devices, a backlight was set; each of the devices in the black state was observed in the direction with a polar angle of 60 degrees relative to the direction normal to the displaying plane by using a contrast tester (EZ-Contrast XL88, by ELDIM); and the difference Δu′ between the maximum u′ and the minimum u′ and the difference Δv′ between the maximum v′ and the minimum v′ were calculated respectively. They were defined as an indicator of color shift, and were evaluated as follows.

A: There was little color shift

B: A certain level of color shift was observed, but no problem in practical use.

C: Color shift, which was too large to be of practical use, was observed.

### (Evaluation of Circular-Form Unevenness)

Each of the devices was observed in both of the normal and oblique directions, and whether the circular-form unevenness occurred or not was visually confirmed. The evaluation was performed as follows.

AA: No circular-form unevenness was observed (no problem in practical use).

A: A certain level of circular-form unevenness was observed, but no problem in practical use.

B: Circular-form unevenness, which was too large to be of practical use, was observed.

| | | Example | Example | Example | Example | Example | Example |
|---|---|---|---|---|---|---|---|
| | | 1 | 2 | 3 | 4 | 5 | 6 |
| Outer Protective Film | Type | TD80U | TD80U | TD80U | TD80U | TD80U | TD80U |
| Second Polarizing Film | | PVA-type liner polarizing film | | | | | |
| Second Optical Film | Type | Film 10 | Film 1 | Film 2 | Film 3 | Film 9 | Film 1 |
| | Degree of | 2.94 | 2.45 | 2.65 | 2.45 | 2.45 | 2.45 |
| | Substitution | | | | | | |
| | Thickness μm | 80 | 60 | 60 | 40 | 60 | 60 |
| | Re(550) nm | 1 | 1 | 1 | 0.7 | 1 | 1 |
| | ΔRe(630-450) nm | −1 | 1 | 1 | 1 | 15 | 1 |
| | Rth(550) nm | −10 | −5 | −5 | −3 | −5 | −5 |
| | ΔRth(630-450) nm | 5 | 10 | 10 | 7 | 45 | 10 |
| Liquid Crystal Cell | | IPS Liquid Crystal Cell | | | | | |
| First Optical Film | Type | Film 1 | Film 1 | Film 2 | Film 3 | Film 1 | Film 1 |
| | Degree of | 2.45 | 2.45 | 2.65 | 2.45 | 2.45 | 2.45 |
| | Substitution | | | | | | |
| | Thickness μm | 60 | 60 | 60 | 40 | 60 | 60 |
| | Re(550) nm | 1 | 1 | 1 | 0.7 | 1 | 1 |
| | ΔRe(630-450) nm | 1 | 1 | 1 | 1 | 1 | 1 |
| | Rth(550) nm | −5 | −5 | −5 | −3 | −5 | −5 |
| | ΔRth(630-450) nm | 10 | 10 | 10 | 7 | 10 | 10 |
| First Polarizing Film | | PVA-type liner polarizing film | | | | | |
| Outer Protective Film | Type | TD80U | TD80U | TD80U | TD80U | Film 3 | Film 3 |
| | Degree of | | | | | 2.45 | 2.45 |
| | Substitution | | | | | | |
| | Thickness μm | | | | | 40 | 40 |
| | Re(550) nm | | | | | 0.7 | 0.7 |
| | ΔRe(630-450) nm | | | | | 1 | 1 |
| | Rth(550) nm | | | | | −3 | −3 |
| | ΔRth(630-450) nm | | | | | 7 | 7 |
| Color Shift | Evaluation | B | A | A | A | B | A |
| | Δu′ | 0.05 | 0.054 | 0.054 | 0.053 | 0.05 | 0.054 |
| | Δv′ | 0.073 | 0.075 | 0.075 | 0.074 | 0.073 | 0.075 |
| Circular-form Unevenness | Evaluation | B | B | B | A | A | A |

| | | Example | Example | Example | Example | Example |
|---|---|---|---|---|---|---|
| | | 7 | 8 | 9 | 10 | 11 |
| Outer Protective Film | Type | TD80U | TD80U | TD80U | TD80U | TD80U |
| Second Polarizing Film | | PVA-type liner polarizing film | | | | |
| Second Optical Film | Type | Film 3 | Film 5 | Film 6 | Film 7 | Film 8 |
| | Degree of Substitution | 2.45 | 2.45 | 2.45 | 2.45 | 2.45 |
| | Thickness μm | 40 | 40 | 40 | 40 | 40 |
| | Re(550) nm | 0.7 | 0.5 | 0.7 | 0.7 | 0.7 |
| | ΔRe(630-450) nm | 1 | 1 | 1 | 1 | 1 |
| | Rth(550) nm | −3 | −2 | −3 | −5 | −4 |
| | ΔRth(630-450) nm | 7 | 6 | 7 | 6 | 8 |
| Liquid Crystal Cell | | IPS Liquid Crystal Cell | | | | |
| First Optical Film | Type | Film 3 | Film 5 | Film 6 | Film 7 | Film 8 |
| | Degree of Substitution | 2.45 | 2.45 | 2.45 | 2.45 | 2.45 |
| | Thickness μm | 40 | 40 | 40 | 40 | 40 |
| | Re(550) nm | 0.7 | 0.5 | 0.7 | 0.7 | 0.7 |
| | ΔRe(630-450) nm | 1 | 1 | 1 | 1 | 1 |
| | Rth(550) nm | −3 | −2 | −3 | −5 | −4 |
| | ΔRth(630-450) nm | 7 | 6 | 7 | 6 | 8 |
| First Polarizing Film | | PVA-type liner polarizing film | | | | |
| Outer Protective Film | Type | Film 3 | Film 5 | Film 6 | Film 7 | Film 8 |
| | Degree of Substitution | 2.45 | 2.45 | 2.45 | 2.45 | 2.45 |
| | Thickness μm | 40 | 40 | 40 | 40 | 40 |
| | Re(550) nm | 0.7 | 0.5 | 0.7 | 0.7 | 0.7 |
| | ΔRe(630-450) nm | 1 | 1 | 1 | 1 | 1 |
| | Rth(550) nm | −3 | −2 | −3 | −5 | −4 |
| | ΔRth(630-450) nm | 7 | 6 | 7 | 6 | 8 |
| Color Shift | Evaluation | A | A | A | A | A |
| | Δu′ | 0.053 | 0.053 | 0.052 | 0.053 | 0.053 |
| | Δv′ | 0.074 | 0.073 | 0.073 | 0.074 | 0.072 |
| Circular-form Unevenness | Evaluation | AA | AA | AA | AA | AA |

| | | Comparative | Comparative | Comparative |
|---|---|---|---|---|
| | | Example 1 | Example 2 | Example 3 |
| Outer Protective Film | Type | TD80U | TD80U | TD81U |
| Second Polarizing Film | | PVA-type liner polarizing film | | |
| Second Optical Film | Type | Film 10 | Film 10 | Film 10 |
| | Degree of Substitution | 2.94 | 2.94 | 2.94 |
| | Thickness μm | 80 | 80 | 80 |
| | Re(550) nm | 1 | 1 | 1 |
| | ΔRe(630-450) nm | −1 | −1 | −1 |
| | Rth(550) nm | −10 | −10 | −10 |
| | ΔRth(630-450) nm | 5 | 5 | 5 |
| Liquid Crystal Cell | | IPS Liquid Crystal Cell | | |
| First Optical Film | Type | Film 4 | Film 9 | Film 10 |
| | Degree of Substitution | 2.45 | 2.45 | 2.94 |
| | Thickness μm | 60 | 60 | 80 |
| | Re(550) nm | 15 | 1 | 1 |
| | ΔRe(630-450) nm | 1 | 15 | −1 |
| | Rth(550) nm | 45 | −5 | −10 |
| | ΔRth(630-450) nm | 10 | 45 | 5 |
| First Polarizing Film | | PVA-type liner polarizing film | | |
| Outer Protective Film | Type | TD80U | TD80U | TD80U |
| Color Shift | Evaluation | C | C | C |
| | Δu′ | — | — | 0.058 |
| | Δv′ | — | — | 0.09 |
| Circular-form Unevenness | Evaluation | B | B | B |

| | | Example | Example | Example | Example | Example | Example |
|---|---|---|---|---|---|---|---|
| | | 21 | 22 | 23 | 24 | 25 | 26 |
| Outer Protective Film | Type | TD80U | TD80U | TD80U | TD80U | TD80U | TD80U |
| Second Polarizing Film | | PVA-type liner polarizing film | | | | | |
| Second Optical Film | Type | Film 1 | Film 1 | Film 2 | Film 3 | Film 1 | Film 1 |
| | Degree of Substitution | 2.45 | 2.45 | 2.65 | 2.45 | 2.45 | 2.45 |
| | Thickness μm | 60 | 60 | 60 | 40 | 60 | 60 |
| | Re(550) nm | 1 | 1 | 1 | 0.7 | 1 | 1 |
| | ΔRe(630-450) nm | 1 | 1 | 1 | 1 | 1 | 1 |
| | Rth(550) nm | −5 | −5 | −5 | −3 | −5 | −5 |
| | ΔRth(630-450) nm | 10 | 10 | 10 | 7 | 10 | 10 |
| Liquid Crystal Cell | | FFS Liquid Crystal Cell | | | | | |
| First Optical Film | Type | Film 10 | Film 1 | Film 2 | Film 3 | Film 9 | Film 1 |
| | Degree of Substitution | 2.94 | 2.45 | 2.65 | 2.45 | 2.45 | 2.45 |
| | Thickness μm | 80 | 60 | 60 | 40 | 60 | 60 |
| | Re(550) nm | 1 | 1 | 1 | 0.7 | 1 | 1 |
| | ΔRe(630-450) nm | −1 | 1 | 1 | 1 | 15 | 1 |
| | Rth(550) nm | −10 | −5 | −5 | −3 | −5 | −5 |
| | ΔRth(630-450) nm | 5 | 10 | 10 | 7 | 45 | 10 |
| First Polarizing Film | | PVA-type liner polarizing film | | | | | |
| Outer Protective Film | Type | TD80U | TD80U | TD80U | TD80U | Film 3 | Film 3 |
| | Degree of Substitution | | | | | 2.45 | 2.45 |
| | Thickness μm | | | | | 40 | 40 |
| | Re(550) nm | | | | | 0.7 | 0.7 |
| | ΔRe(630-450) nm | | | | | 1 | 1 |
| | Rth(550) nm | | | | | −3 | −3 |
| | ΔRth(630-450) nm | | | | | 7 | 7 |
| Color Shift | Evaluation | B | A | A | A | B | A |
| | Δu′ | 0.051 | 0.053 | 0.052 | 0.053 | 0.051 | 0.053 |
| | Δv′ | 0.072 | 0.074 | 0.076 | 0.075 | 0.072 | 0.073 |
| Circular-form Unevenness | Evaluation | B | B | B | A | A | A |

| | | Example | Example | Example | Example | Example |
|---|---|---|---|---|---|---|
| | | 27 | 28 | 29 | 30 | 31 |
| Outer Protective Film | Type | TD80U | TD80U | TD80U | TD80U | TD80U |
| Second Polarizing Film | | PVA-type liner polarizing film | | | | |
| Second Optical Film | Type | Film 3 | Film 5 | Film 6 | Film 7 | Film 8 |
| | Degree of Substitution | 2.45 | 2.45 | 2.45 | 2.45 | 2.45 |
| | Thickness μm | 40 | 40 | 40 | 40 | 40 |
| | Re(550) nm | 0.7 | 0.5 | 0.7 | 0.7 | 0.7 |
| | ΔRe(630-450) nm | 1 | 1 | 1 | 1 | 1 |
| | Rth(550) nm | −3 | −2 | −3 | −5 | −4 |
| | ΔRth(630-450) nm | 7 | 6 | 7 | 6 | 8 |
| Liquid Crystal Cell | | FFS Liquid Crystal Cell | | | | |
| First Optical Film | Type | Film 3 | Film 5 | Film 6 | Film 7 | Film 8 |
| | Degree of Substitution | 2.45 | 2.45 | 2.45 | 2.45 | 2.45 |
| | Thickness μm | 40 | 40 | 40 | 40 | 40 |
| | Re(550) nm | 0.7 | 0.5 | 0.7 | 0.7 | 0.7 |
| | ΔRe(630-450) nm | 1 | 1 | 1 | 1 | 1 |
| | Rth(550) nm | −3 | −2 | −3 | −5 | −4 |
| | ΔRth(630-450) nm | 7 | 6 | 7 | 6 | 8 |
| First Polarizing Film | | PVA-type liner polarizing film | | | | |
| Outer Protective Film | Type | Film 3 | Film 5 | Film 6 | Film 7 | Film 8 |
| | Degree of Substitution | 2.45 | 2.45 | 2.45 | 2.45 | 2.45 |
| | Thickness μm | 40 | 40 | 40 | 40 | 40 |
| | Re(550) nm | 0.7 | 0.5 | 0.7 | 0.7 | 0.7 |
| | ΔRe(630-450) nm | 1 | 1 | 1 | 1 | 1 |
| | Rth(550) nm | −3 | −2 | −3 | −5 | −4 |
| | ΔRth(630-450) nm | 7 | 6 | 7 | 6 | 8 |
| Color Shift | Evaluation | A | A | A | A | A |
| | Δu′ | 0.052 | 0.053 | 0.053 | 0.053 | 0.052 |
| | Δv′ | 0.074 | 0.074 | 0.073 | 0.074 | 0.072 |
| Circular-form Unevenness | Evaluation | AA | AA | AA | AA | AA |

| | | Comparative | Comparative | Comparative |
|---|---|---|---|---|
| | | Example 21 | Example 22 | Example 23 |
| Outer Protective Film | Type | TD80U | TD80U | TD81U |
| Second Polarizing Film | | PVA-type liner polarizing film | | |
| Second Optical Film | Type | Film 4 | Film 9 | Film 10 |
| | Degree of Substitution | 2.45 | 2.45 | 2.94 |
| | Thickness μm | 60 | 60 | 80 |
| | Re(550) nm | 15 | 1 | 1 |
| | ΔRe(630-450) nm | 1 | 15 | −1 |
| | Rth(550) nm | 45 | −5 | −10 |
| | ΔRth(630-450) nm | 10 | 45 | 5 |
| Liquid Crystal Cell | | FFS Liquid Crystal Cell | | |
| First Optical Film | Type | Film 10 | Film 10 | Film 10 |
| | Degree of Substitution | 2.94 | 2.94 | 2.94 |
| | Thickness μm | 80 | 80 | 80 |
| | Re(550) nm | 1 | 1 | 1 |
| | ΔRe(630-450) nm | −1 | −1 | −1 |
| | Rth(550) nm | −10 | −10 | −10 |
| | ΔRth(630-450) nm | 5 | 5 | 5 |
| First Polarizing Film | | PVA-type liner polarizing film | | |
| Outer Protective Film | Type | TD80U | TD80U | TD80U |
| Color Shift | Evaluation | C | C | C |
| | Δu′ | — | — | 0.058 |
| | Δv′ | — | — | 0.092 |
| Circular-form Unevenness | Evaluation | B | B | B |

What is claimed is:

1. An IPS or FFS mode liquid crystal display device comprising:
a first and a second polarizers of which polarizing axes are perpendicular to each other;
a liquid crystal layer disposed between the first and the second polarizers; and
a first optical film disposed between the first polarizer and the liquid crystal cell and a second optical film disposed between the second polarizer and the liquid crystal cell; wherein
the first and the second optical films fulfill the conditions of formulas (I)-(IV); and
the first optical film consists of a layer with low degree of total acyl substitution comprising a cellulose acylate fulfilling the condition of formula (1) as a main ingredient, or comprises the layer with low degree of total acyl substitution and an outermost layer with high degree of total acyl substitution comprising a cellulose acylate fulfilling the condition of formula (2) as a main ingredient, disposed on at least one surface of the layer with low degree of total acyl substitution:
0 nm≦Re(550)≦10 nm (I)

|Rth(550)≦25 nm (II)

|Re(630)−Re(450)≦10 nm (III)

|Rth(630)−Rth(450)≦35 nm (IV)
where, in formulas (I)-(IV), Re(λ) represents retardation (nm) in plane at a wavelength of λ nm, and Rth(λ) represents retardation (nm) at the thickness direction at a wavelength of λ nm;
2.0<Z1<2.7 (1)
where Z1 represents a total substitution degree of the cellulose acylate used as the main ingredient of the layer with low degree of total acyl substitution; and
2.7<Z2 (2)
where Z2 represents a total substitution degree of the cellulose acylate used as the main ingredient of the outermost layer with high degree of total acyl substitution.

2. The liquid crystal display device of claim 1, wherein the second optical film comprises a layer with low degree of total acyl substitution comprising a cellulose acylate fulfilling the condition of formula (1) as a main ingredient, and an outermost layer with high degree of total acyl substitution, disposed on at least one surface of the layer with low degree of total acyl substitution, comprising a cellulose acylate fulfilling the condition of formula (2) as a main ingredient:

3. The liquid crystal display device of claim 1, wherein the thicknesses of the first and the second optical films are from 30 to 130 micro meters.

4. The liquid crystal display device of claim 1, further comprising a third and a fourth optical films disposed at the outside of the first and a second polarizers, wherein at least one of the third and fourth optical films fulfills the conditions of formulas (I)-(IV), and comprises a layer with low degree of total acyl substitution comprising a cellulose acylate fulfilling the condition of formula (1) as a main ingredient, and an outermost layer with high degree of total acyl substitution, disposed on at least one surface of the layer with low degree of total acyl substitution, comprising a cellulose acylate fulfilling the condition of formula (2) as a main ingredient.

5. The liquid crystal display device of claim 1, wherein the layer with low degree of total acyl substitution comprises a non-phosphate ester compound.

6. The liquid crystal display device of claim 5, wherein the outermost layer with high degree of total acyl substitution comprises a non-phosphate ester compound; and a ratio by mass of the non-phosphate ester compound with respect to the cellulose acylate in the outermost layer with high degree of total acyl substitution is less than a ratio by mass of the non-phosphate ester compound with respect to the cellulose acylate in the layer with low degree of total acyl substitution.

7. The liquid crystal display device of claim 5, wherein the non-phosphate ester compound is a polyester compound having at least one aromatic ring.

8. The liquid crystal display device of claim 1, wherein the cellulose acylate in the layer with low degree of total acyl substitution fulfills the conditions of formulas (3)-(5):
1.0<X1<2.7 (3)
0≦1<1.5 (4)
X1+Y1=Z1 (5)
where, in formulas (3)-(5), X1 represents a degree of acetylation of the cellulose acylate used as the main ingredient of the layer with low degree of total acyl substitution; Y1 represents a degree of acyl-substitution having 3 or more carbon atoms of the cellulose acylate used as the main ingredient of the layer with low degree of total acyl substitution; and Z1 represents a total substitution degree of the cellulose acylate used as the main ingredient of the layer with low degree of total acyl substitution.

9. The liquid crystal display device of claim 1, wherein the cellulose acylate in the outermost layer with high degree of total acyl substitution fulfills the conditions of formulas (6)-(8):
1.2<X2<3.0 (6)
0≦Y2<1.5 (7)
X2+Y2=Z2 (8)
where, in formulas (6)-(8), X2 represents a degree of acetylation of the cellulose acylate used as the main ingredient of the outermost layer with high degree of total acyl substitution; Y2 represents a degree of acyl-substitution having 3 or more carbon atoms of the cellulose acylate used as the main ingredient of the outermost layer with high degree of total acyl substitution; and Z2 represents a total substitution degree of the cellulose acylate used as the main ingredient of the outermost layer with high degree of total acyl substitution.

10. The liquid crystal display device of claim 1, wherein the outermost layer with high degree of total acyl substitution is disposed on both of the surfaces of the layer with low degree of total acyl substitution. The formulations of the two outermost layers with high degree of total acyl substitution may be same or different to each other.

11. The liquid crystal display device of claim 1, wherein the number of carbon atoms contained in the acylate group of the cellulose acylate in the layer with low degree of total acyl substitution and/or the outermost layer with high degree of total acyl substitution is from 2 to 4.

12. The liquid crystal display device of claim 1, wherein the acylate group of the cellulose acylate in the layer with low degree of total acyl substitution and/or the outermost layer with high degree of total acyl substitution is cellulose acetate.

13. The liquid crystal display device of claim 1, wherein the averaged thickness of the layer with low degree of total acyl substitution is from 30 to 100 micro meters; and the averaged thickness of at least one of the outermost layer with high degree of total acyl substitution is not less than 0.2% and less than 25% of the averaged thickness of the layer with low degree of total acyl substitution.
